(19) United States
(12) Patent Application Publication
(10) Pub. No.: US 2007/0095899 A1
(43) Pub. Date: May 3, 2007

(54) Global identification authentication system

(76) Inventors: Donald Mark Meade, Barrie (CA); Paul James Simpson, Newmarket (CA)

Correspondence Address: MICHAEL I KROLL, 171 STILLWELL LANE, SYOSSET, NY, 11791, US

(21) Appl. No.: 11/585,322

(22) Filed: Oct. 23, 2006

Related U.S. Application Data
(60) Provisional application No. 60/730,835, filed on Oct. 28, 2005.

(51) Int. Cl. G06K 5/00

(52) U.S. Cl. 235/380

(57) ABSTRACT

The present invention is a global identification authentication system where fee based subscribers can verify the authenticity of personal identification submitted to the subscribers with substantially immediate access, by non-governmental entities, to identification databases to verify whether any particular identification is valid, invalid or non-existing in the identification document databases.

### RELATED APPLICATIONS

This application is subject to U.S. provisional application Ser. No. 60/730,835 filed 28 Oct. 2005.

Please incorporate by reference all information in said provisional application into this instant application.

### BACKGROUND OF THE INVENTION

1. Field of the Invention

The present invention relates generally to identification documents and, more specifically, to a global identification authentication system whereby subscribers, for a nominal fee, can verify the authenticity of personal identification submitted to said subscribers.

It is an object of the identification authentication system of the present invention to provide a system that enables substantially immediate access, by non-governmental entities, to most types of identification databases to verify whether any particular identification is valid, invalid or non-existing in said databases.

Typifying an example in the prior art, only governmental authorities have been able to authenticate passports and drivers licenses for a person's identification.

Recent changes to various national, state, and provincial laws (e.g., the REAL ID Act in the United States) have provided for the amalgamation of departmental and ministerial information and for the requirement of singular driver's license and that any particular driver may only maintain a license in a single jurisdiction. The same holds true for a wide range of data bases whereby individuals entering these bases are being cross checked to assure the person is correct.

Other private sector business concerns have previously used less developed systems to attempt access to other information, but have never previously sought to gain live access for authentication of identification and never sought global identification.

In the prior art, there is no reliable method to verify an ID. It is estimated that a significant percentage of the population may have counterfeit identification. This concept holds true in respect to fraudulent or stolen Licenses as well.

Perhaps as a result of recently heightened security and/or other concerns, a standard universal system for identification is now of great concern to federal, state and provincial lawmakers.

Among other reasons, the global identification authentication system of the present invention was created: to address the various problems encountered by airlines, border personnel, retail, financial institutes and other various entities seeking ID verification, and/or to provide the private sector with a means to access and validate an ID. Accordingly, the identification authentication system of the present invention allows entities in the private sector to also access certain United States federal and state governments' databases, along with Canada's federal and provincial electronic databases, and/or other databases, to immediately access and verify the status of any presented ID on demand.

The inventors of the identification authentication system according to the present invention have developed a means to provide personal inquiries and responses for a simple personal information challenge such as digits of a Social Security or Social Insurance number, cell or home phone number and/or other forms of identification currently in use.

The system comprises: Wide range of ID base, ID holder, Account user, bank account information, Terminal access when programmed, System direct payment(s), Multiple Verification Requests, Software, Central switching and processing facility, Database providers, Firewall(s), Identification databases (containing personal ID holder information), and/or flagged responses: such as requesting response to phone numbers, social security or social insurance numbers.

An identification document holder submits their personal identification document to be verified. The information relating to the document is inputted, in the form of a verification request, through a computer terminal substantially local to the holder. The identification document may also be swiped in the modified ATM terminal and/or ID document specific number may also be keyed in. The system can provide direct billing from an account user or ID holder's account at the time of verification request. This direct billing can be performed by a software component that may preferably be, but is not necessarily, provided according to the invention. For example, when an established account user accesses the system to make a verification request, they may also be asked to approve payment of a fee (e.g. $2.00 US) to be immediately withdrawn from their bank account, using previously provided and/or pre-approved account information, and deposited into a bank account maintained according to the system to receive payments.

The authentication request is transferred from the terminal and/or routed, preferably but not necessarily by way of said software component/through servers in a central processing facility to the programmed database provider for an immediate search of the identification document requested in the database against the queried ID document provided.

The database access provider has established a firewall to block access to extraneous and/or confidential personal ID holder information, other than information corresponding to one of the following flagged response forms, namely, whether the queried identification document information is valid, invalid, or non-existing, in the subject database or inquiries for personal information such as certain phone numbers, social security or social insurance numbers.

The database access providers guarantee safe and secure usage of the system, by not storing data strictly for the moment used and can not compromise access to personal document holder information.

The worldwide system is adapted to carry up to one hundred (100) million uses/verification requests per day, with substantially simultaneous use and return of up to 100,000 flagged responses within seconds. These quantities may be estimates based on forecasted usage. Substantially simultaneously uses are contemplated to be ones that might typically be encountered during peak periods and/or busy times when many airlines, car rental facilities, and other users might be sending verification requests.

The hardware, software, and/or providers' systems may be modified, within the scope of the invention, to maximize system capabilities and response processing capacities and efficiencies.

In addition to all of the aforesaid, the identification authentication system of the present invention provides substantially seamless access through the Internet, or another computer network, to enable rapid verification of an individual's ID information.

The verification request goes substantially directly to a central processing facility that provides and monitors such requests. If a request for payment is made and approved by a user, the system preferably scans relevant databases so as to reveal whether the queried ID information is valid, invalid, or non-existing and requires personal questions.

The identification authentication system of the present invention might enable inquiries to be made over both an “ATM” network and/or the Internet. Such an ATM query might be expected to deliver a response according to the invention in less than, in most cases, twenty seconds. As aforesaid, substantially at the time of an inquiry being placed through the ATM network, such an inquiry might trigger a payment process of the relevant fee (e.g., $2.00 US) directly out of a user's bank account (e.g., a corporate bank account). The Internet option might allow an agent to enter an ID holder's information into a personal computer and immediately retrieve the necessary information. Similarly, such an Internet option might also incorporate a substantially immediate payment mechanism.

The inventors are not aware of any systems to authenticate over live data bases of an ID substantially within moments. The introduction of a global network of data bases enabling worlwide for live access is in itself unique.

Moreover, the inventors are not aware of any prior art systems that have provided wide-scale and not global access to ID verification systems. Any previous systems may only have provided such users with access to a database of individual state/province to perform a license validation or ID validation. Similarly, the use of such a prior art (individual state type inquiry) system would not have revealed any one of a countless number of driving infractions or misuse of fraudulent ID that may have occurred in other states and/or province not searched.

Infrastructures may exist for retrieving other types of information relating to ID. Such information can include credit status with respect to a prospective purchase and insurance information. According to the invention, these infrastructures may be employed to access ID document information through partnership with existing infrastructure service providers.

Car rental agencies might be able to use the global identification authentication system of the present invention to immediately authenticate licensing as presented of prospective renters prior to completion of a transaction. At present, there may be in the order of approximately 500,000 such transactions being performed per day in the United States and Canada. Included among these transactions are direct transactions to individual drivers as well as other transactions, such as vehicles rented to collision repair centers, and the like, for customer use during vehicle maintenance and repair.

2. Description of the Prior Art

While the prior art systems may be suitable for the purposes for which they were designed, they would not be as suitable for the purposes of the present invention, as hereinafter described.

Any previous systems may only have provided such users with access to a database of an individual state (i.e., as may have been offered by an individual state jurisdiction on its own) and such systems have only been known, by the inventors, to perform a license validation. Similarly, the use of such a prior art would not have revealed all other identification presented for authentication and would not have demonstrated access to live data bases.

Therefore it is felt that a global need exists whereby certain governing authority and the public sector, whether individuals or businesses, require access to verification through use of the system of the present invention.

### SUMMARY OF THE PRESENT INVENTION

The identification authentication system of the present invention provides both a wireless and/or land line based system whereby subscribers can verify whether a presented article of personal identification is valid, invalid or fraudulent by submitting a request for verification to the authentication system which will electronically communicate in real time with the relevant governing database providing the accepted authentication and verbal request necessary to determine whether the personal identification is authentic.

The means of submitting the request for verification of an identification article can be any electronic device capable of sending and receiving electronic communications whether by keyboard where the personal identification information is manually entered or electronically scanned from the personal identification document having the necessary information encoded on magnetic stripe or microchip.

In operation, an entity contracts with the identification authentication provider to verify on demand whether an identification article is valid, invalid or non-existent.

A primary object of the present invention is to provide an identification authentication system for verifying a presented personal identification document.

Another object of the present invention is to provide an identification authentication system wherein subscribers can input unique identification document information and substantially instantaneously receive a status as to the authenticity of said identification document.

Yet another object of the present invention is to provide a global identification authentication system wherein subscribers can input unique identification document information using a keypad or document reader.

Additional objects of the present invention will appear as the description proceeds.

The present invention overcomes the shortcomings of the prior art by providing a global identification authentication system whereby subscribers, for a nominal fee, can verify the authenticity of personal identification submitted to said subscribers on request.

The foregoing and other objects and advantages will appear from the description to follow. In the description reference is made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is a chart of the components of the ID authentication verification system;

FIG. 2 is an illustrative view of the present invention in use;

FIG. 3 is an an illustrative view of a central processing facility;

FIG. 4 is an illustrative view of the present invention in use;

FIG. 5 is an illustrative view of processing for a verification request;

FIG. 6 is an illustrative view of processing for a verification request;

FIG. 7 is an illustrative view of processing for a verification request;

FIG. 8 is an illustrative view of the scope of the present invention; and

FIG. 9 is a block diagram of processing for a verification request.

### DESCRIPTION OF THE REFERENCED NUMERALS

Turning now descriptively to the drawings, in which similar reference characters denote similar elements throughout the several views, the Figures illustrate the adipose tissue treatment of the present invention. With regard to the reference numerals used, the following numbering is used throughout the various drawing figures.

10 global identification authentication system

12 account user

14 identification document holder

16 identification document holder

18 financial processor information

20 input device

22 system payment bank account

24 verification request

26 server storage facility

28 central processing facility

30 Database access provider

32 provider firewall

34 identification document database

36 flagged responses

38 Internet

40 law enforcement

42 private sector

44 encoded data

46 point of sale

### DETAILED DESCRIPTION OF THE PREFERRED EMBODIMENT

The following discussion describes in detail one embodiment of the invention. This discussion should not be construed, however, as limiting the invention to those particular embodiments, practitioners skilled in the art will recognize numerous other embodiments as well. For definition of the complete scope of the invention, the reader is directed to appended claims.

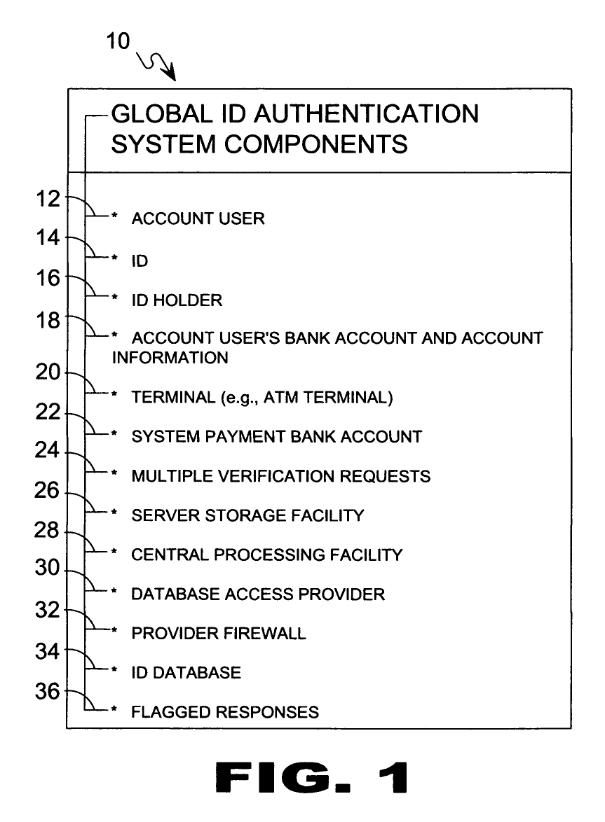

Referring to FIG. 1, shown is a chart of the components of the ID authentication verification system. The identification authentication system of the present invention 10 provides means for verifying the authenticity of a personal identification document. Generally, the system comprises: ID 14, ID holder 16, Account user 12, Account user's bank account & account information 18, Terminal (e.g., ATM terminal) 20, System payment bank account 22, Multiple Verification Requests 24, Server Storage facility 26, Central Processing facility 28, Database access provider 30, Provider firewall 32, identification document databases (containing personal ID holder information) 34, and/or flagged responses 36: queried ID document information is (a) valid, (b) invalid, or (c) non-existing.

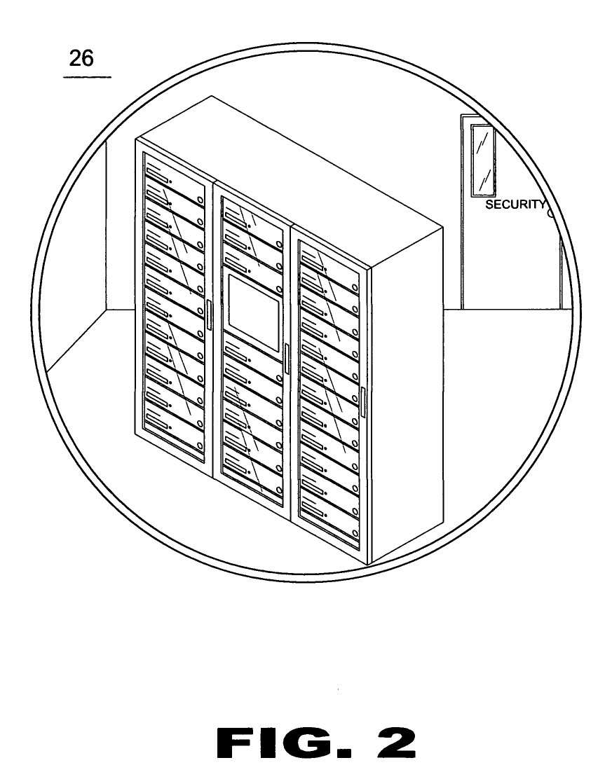

Referring to FIG. 2, shown is an illustrative view of the present invention in use. One method of entering the identification document 14 information is using a device 20 that will read encoded data stored on the identification document, such as a magnetic stripe 44 whose information will be electronically conveyed to the central processing facility for verification with the appropriate identification document database provider. In the preferred embodiment, the database provider will return a status to the verification requester 12 of the identification document indicative of a valid, invalid or the non-existence of the identification document.

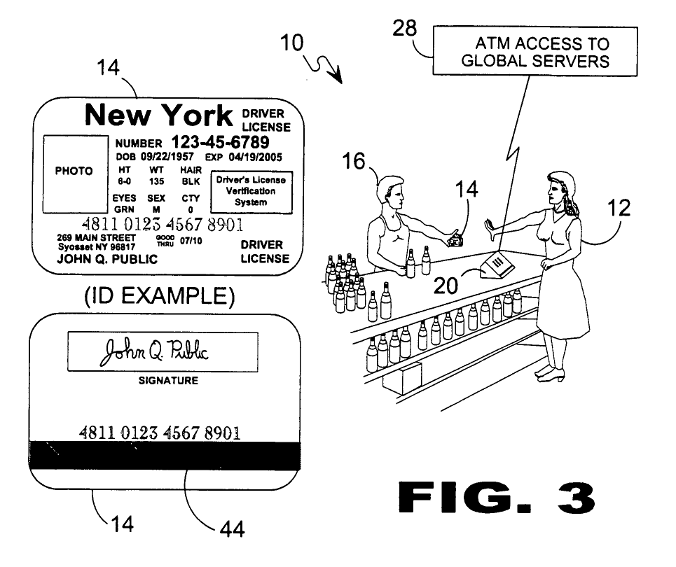

Referring to FIG. 3, shown is an illustrative view of a central processing facility. As aforementioned, an identification document holder 16 submits their personal identification document 14 to be verified. The identification 44 document may be swiped 20 or the identification document specific number may be keyed in. The verification request is transferred from the terminal and/or routed, preferably but not necessarily by way of said software component/through a central processing facility 28 to a relevant database access provider for a substantially immediate search of a relevant and current identification document database against the queried ID document information returning a status of valid, invalid, or non-existing, in the subject database.

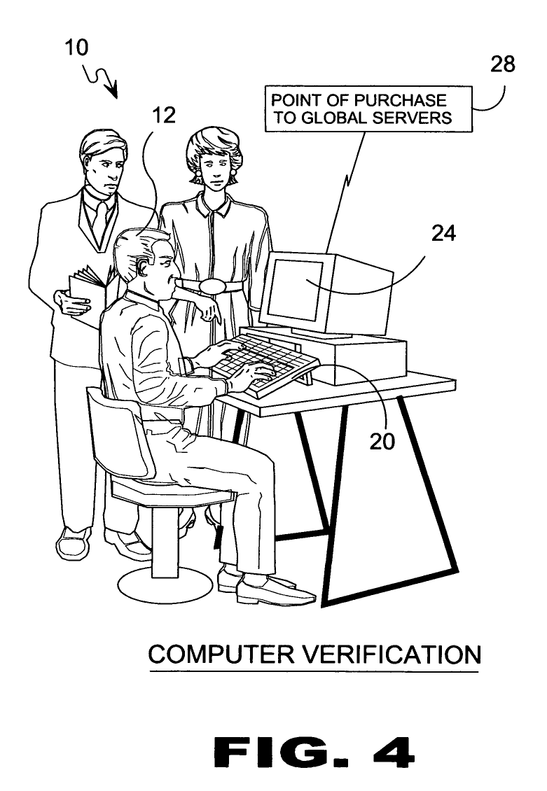

Referring to FIG. 4, shown is an illustrative view of the present invention in use. The global identification authentication system 10 provides that a system user 12 can key 20 in the relevant information from an identification document whereupon the verification request 24 is transferred from the terminal through a central processing facility 28 to the appropriate database access provider for an immediate search of the current identification document database against the queried ID document information returning a status of valid, invalid, or non-existent.

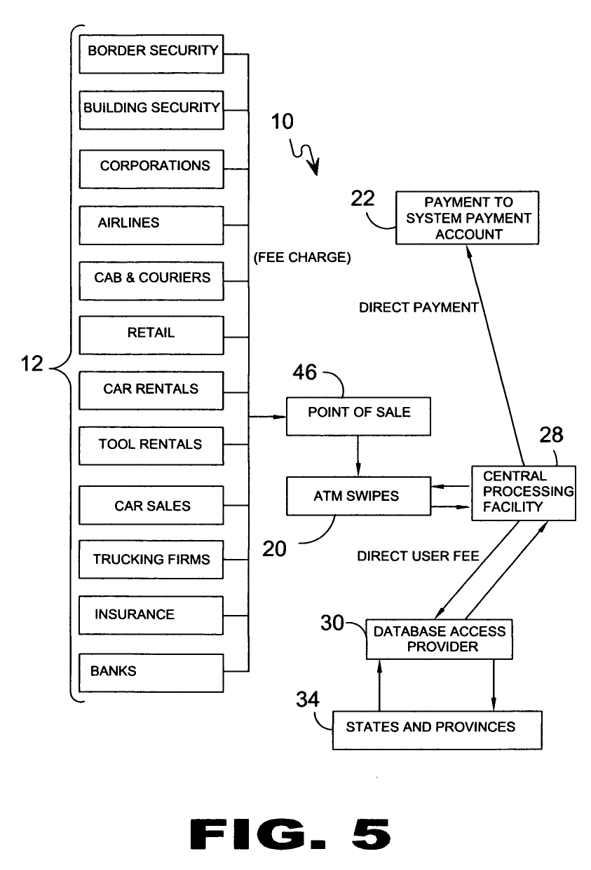

Referring to FIG. 5, shown is a flow diagram of the present invention. Users 12 of the global identification authentication system 10 may at the point of sale 46 swipe 20 an identification document using a modified ATM terminal, wherethen the ATM terminal may also provide direct billing 22 to an account user's or ID holder's account at the time of the verification request. The verification request is transferred from the ATM terminal 20 to a central processing facility 38 to a database access provider 30 for an immediate search of the current identification document database 34 which searches the database using the information provided and returns a search status as to whether the queried identification document information is valid, invalid, or non-existing, in the subject database.

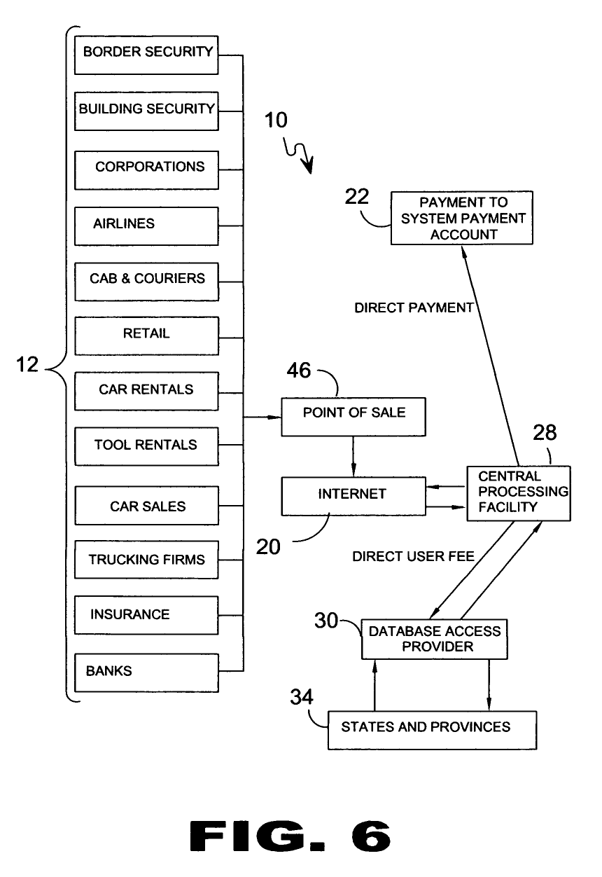

Referring to FIG. 6, shown is a flow diagram of the present invention. As illustrated, user 12 can take the form of any business, individual or agency having need of verifying the authenticity of a personal identification document may input the relevant ID document information at the point of sale 46 using any electronic device wherethen the verification request is transferred through the Internet 20 to a central processing facility 28 to a database access provider 30 for an immediate search of the current identification document database 34 which searches the database using the information provided and returns a search status as to whether the queried identification document information is valid, invalid, or non-existing, in the subject database. The present invention also provides that a processing fee can be directly deposited into the system payment account 22.

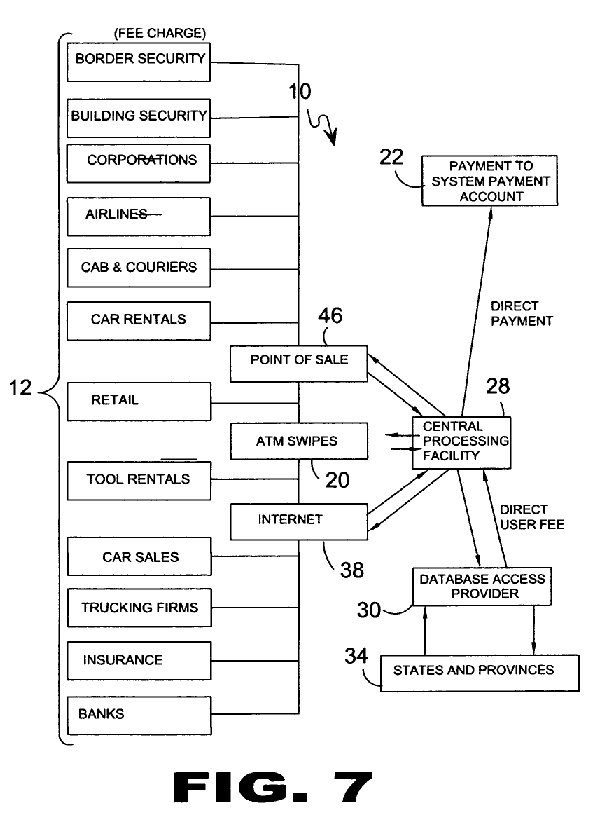

Referring to FIG. 7, shown is a flow diagram of the present invention. The global identification authentication system 10 of the present invention provides that an identification document holder submits their personal identification document to be verified to an account user 12. The information is input electronically using a card reader 20 (e.g., a modified ATM terminal) or keyed 20 into a computer terminal using the identification document specific information and forwarded to the central processing facility 28 via ATM swipe 20 and/or the Internet 38, which can occur at point of sale 46. The central processing facility 28 submits the verification request to the database access provider 30 for the appropriate information database 34 for authentication. The present invention also provides that a direct billing 22 function may be incorporated where the account user's 12 or ID holder's 12 account is charged at the time of verification request. This direct billing may be performed by a software component that may preferably be, but is not necessarily, provided according to the invention. For example, when an established account user accesses the system to make a verification request, they may also be asked to approve payment of a fee to be immediately withdrawn from their bank account, using previously provided and/or pre-approved account information, and deposited into a bank account maintained according to the system to receive payments wherethen the verification request is transferred from the terminal and/or routed, preferably but not necessarily by way of said software component/through a central processing facility to a relevant database access provider for a substantially immediate search of a relevant and current identification document database against the queried ID document information. The database access provider preferably but not necessarily has established a unique firewall to block access to and/or return of extraneous and/or confidential personal ID holder information, other than information corresponding to one of the following flagged response forms, namely, whether the queried identification document information is valid, invalid, or non-existing, in the subject database. The database access providers preferably ensure safe and secure usage of the system, possibly by establishment of the firewall as aforesaid, in a manner that doesn't compromise and blocks further access to personal document holder information.

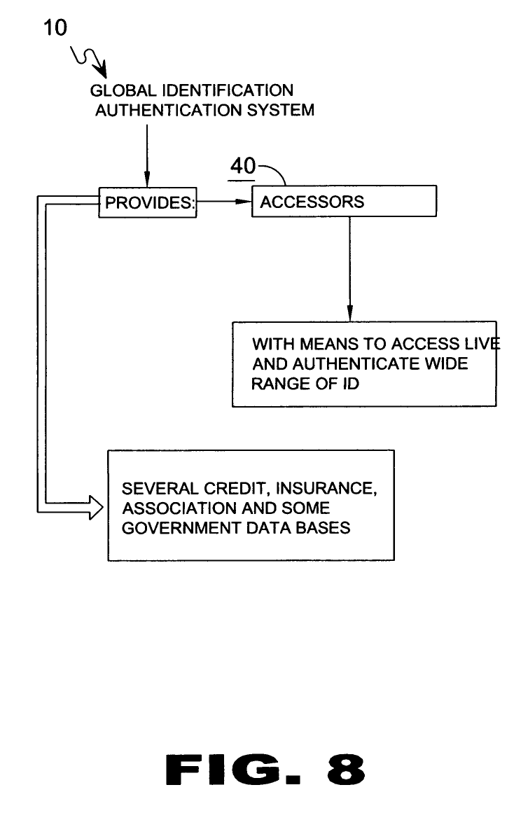

Referring to FIG. 8, shown is an illustrative view of the scope of the present invention. The present invention 10 Global Identification Authentication System provides accessors 40 access to means for verifying whether a particular ID submitted by an ID holder is valid, invalid or non-existent within the relevant ID document database.

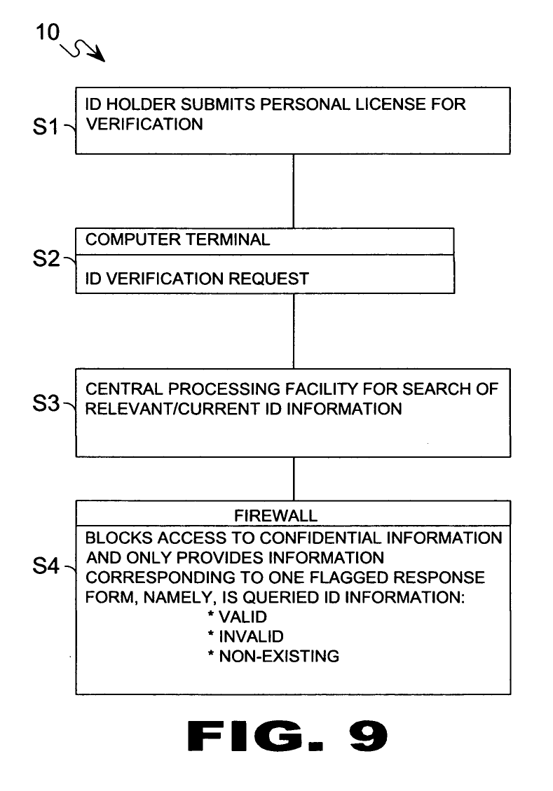

Referring to FIG. 9, shown a block diagram of processing for a verification request. In step S1, an identification document holder submits their personal identification document to be verified, wherethen in step S2 the identification document may be swiped or the identification document specific number may be keyed in. In step S3, the verification request is transferred from the terminal and/or routed through a central processing facility to a relevant database access provider for a substantially immediate search of a relevant and current identification document database against the queried ID document information returning a status of valid, invalid, or non-existing, in the subject database and preferably in step S4, the database access provider provides means for blocking access to confidential personal ID holder information, other than information related to the verification process.

What is claimed is new and desired to be protected by Letters Patent is set forth in the appended claims:

1. A system for verifying an identification document for use with electronic databases containing document specific information, said system comprising:
account users' bank account and account information;
multiple computer terminals;
at least one system payment bank account;
multiple verification requests;
a software component;
a central processing facility;
a provider to access said electronic databases;
a provider firewall;
with the system adapted to generate flagged responses to said verification requests indicating whether any one queried identification document is taken from the group consisting of valid, invalid, and non-existing;
wherein a holder submits their identification document to be verified;
wherein the information relating to the identification document is inputted, in the form of a document verification request, into a computer terminal;
wherein the document is swiped or keyed into one of the multiple computer terminals;
wherein the terminal provides direct billing to an account user's or identification document holder's account at the time of verification request;
wherein this direct billing is performed by a software component;
wherein, when an established account user accesses the system to make a verification request, they are also asked to approve payment to be immediately withdrawn from their bank account, using previously provided and pre-approved account information, and deposited into a bank account maintained according to the system to receive payments;
wherein the verification request is transferred from the terminal and routed by way of said software component through a central processing facility to a relevant database access provider for a substantially immediate search of a relevant and current identification document database against the queried document information;
wherein the database access provider has established a unique firewall to block access to and return of extraneous and confidential personal ID holder information, other than information corresponding to one of the following flagged response forms, namely, whether the queried identification document information is valid, invalid, or non-existing, in the subject database;
wherein the database access providers ensure safe and secure usage of the system, by establishment of the firewall as aforesaid, in a manner that doesn't compromise and blocks further access to personal identification holder information; and
wherein the system is adapted to carry up to one hundred (100) million uses/verification requests per day, with substantially simultaneous use and return of up to 100,000 flagged responses within seconds.

2. A method for verifying an identification document for use with electronic databases containing document specific information, said method comprising:
registering users requiring verification of an identification document;
providing access to a request for verification of an identification document; assessing a fee to the registered user for the service of verifying the authenticity of an identification document;
transmitting the completed verification request to the service provider of the identification verification service;
communicating with the identification document database with a request for verification of an identification document;
receiving a status from the identification document database denoting valid, invalid or non-existent; and
transmitting the identification document status to the requesting registered user.

3. The method of claim 2, wherein registering users includes:
creating an account for a user with user identifiable information; and
acquiring user's information regarding the financial entity handling the payment processing of user incurred service fees.

4. The method of claim 2, wherein providing access to a request for authentication of an identification document is taken from the group consisting of:
creating an identification document request form that can be filled out electronically;
providing a card reader capable of reading an identification document magnetic stripe; and
providing a card reader capable of reading an identification document microchip.
